(19) United States
(12) Patent Application Publication
(10) Pub. No.: US 2012/0174853 A1
(43) Pub. Date: Jul. 12, 2012

(54) Temperature Sensing Food Stuff Label

(76) Inventor: Robert Wilson, Milwaukee, WI (US)

(21) Appl. No.: 13/343,223

(22) Filed: Jan. 4, 2012

Related U.S. Application Data
(60) Provisional application No. 61/430,412, filed on Jan. 6, 2011.

(51) Int. Cl. G01D 21/00

(52) U.S. Cl. 116/206

(57) ABSTRACT

A food product temperature and freshness monitoring device and method is provided. The device comprises a thermochromic seal or label that monitors the temperature of food stuff and alters its appearance when the food temperature rises above a predefined limit for a given period of time. The present invention provides a device with a predefined temperature for which the pigment of an imbedded material alters its color from a first color to a second color, and does not revert to its original color after passing a threshold time-temperature. The pigment is sandwiched between a layer of thermally conductive material on a first, product-facing side, followed by a thermally insulative material on a second, outward-facing side. The seal provides an indicator to determine whether food stuff has been shipped and stored in an appropriate environment to prevent spoilage. The seal monitors the food temperature, as opposed to the ambient air temperature.

### CROSS REFERENCE TO RELATED APPLICATION

This application claims the benefit of U.S. Provisional Application No. 61/430,412 filed on Jan. 6, 2011, entitled “Safe Seal.”

### BACKGROUND OF THE INVENTION

1. Field of the Invention

The present invention relates to food freshness labels and methods for monitoring food temperature. More specifically, the present invention provides a label or seal that changes its pigment or appearance when the associated food product rises above a preset temperature limit that indicates an environment for food spoilage and a danger to consumers.

2. Description of the Prior Art

Perishable food products are generally shipped long distances from production locations to distribution centers and markets, wherein they are presented to a consumer. The food must remain in a chilled environment to slow the decomposition process or prevent the buildup of mold or fungus while the product is being shipped and stored. Consuming spoiled food, particularly meat products, can endanger the health of a consumer resulting from the spread of infectious agents or toxic agents that are poisonous or incompatible with the human digestion system. These agents may range from bacteria or parasites, to mold and fungus.

Presently, there is no adequate means for determining whether a food product has remained in a chilled or refrigerated environment during its passage from production to purchase. Freshness dates and born-on dates were implemented to gauge the shelf-life of meat and other food products; however these dates do not provide insight into the storage and preparation of the food prior to being purchased. Food producers and farmers must rely on transportation organizations and grocery chains to maintain proper temperature of their food while in transit to and in storage within a grocery store. If a meat, dairy, or frozen food product becomes too warm, it can cause the food to spoil and make it unsafe for subsequent consumption. This can lead to consumers becoming ill and even cause death in extreme cases. As a result, producers are blamed and an entire line of products may be destroyed to prevent further contamination, when in reality the fault may lie in an inadequate transportation or storage environment, or negligence of a particular transporter.

A need arises, therefore, for a system that monitors individual food products as they are transported and stored, and one that alerts consumers of individual product freshness and condition. A system is needed that reduces error in current methods for detecting and tracking contaminated food. The present invention provides such a device and method to fulfill this need. The present invention provides a food label with a thermochromic pigment that permanently alters its color upon passing a threshold temperature for a given period of time. The pigment and label are situated such that the label is not monitoring an outside or ambient air temperature surrounding the food product, but the food product temperature itself. The label may be placed within a packaging or incorporate a means to measure internal temperature of a food product such as meat and dairy products. A consumer, upon reviewing the label, is given notice whether the particular product has been placed in an appropriate environment during its transit from packaging to purchase.

Several devices have been disclosed in the prior art that describe color changing labels and devices that monitor food products. These devices describe specific compounds that exhibit a color change when introduced to a predefined temperature limit for a given period of time. These patents are chemical compounds or compositions for the purposes of creating a food packaging label. They fail to provide a label that facilitates measuring the product itself, as opposed to the ambient environment thereabout.

U.S. Published Patent Application No. 2003/0143188 to Ribi is one such invention that describes a method and composition that undergoes a color change at a predetermined transition temperature. The thermochromic composition is contemplated for use with an ingestible that has been stored, and used to determine its suitability for consumption. Specifically, a polydiacetylene polymer having a transition temperature range of −10 degrees to 200 degrees Celsius is claimed. While this device and method provides a similar tool for measuring temperature change in an ingestible food product, the present invention provides a broader range of thermochromic labels for use than polydiacetylene. The present invention further provides an assembly structure that facilitates thermal conduction from the product side, while insulating the outward facing side of the label.

U.S. Pat. No. 5,254,473 to Patel describes another method of determining the elapse shelf life of a perishable product comprising several steps that include packaging a product with an indicator device capable of changing color in relationship to its exposure above a base line temperature and time of exposure. The indicator comprises a substrate of binder, binder/reactant, an indicator of at least one acid sensitive pH dye, and an activator of at least one base. The Patel patent similarly does not disclose an assembly for the packaging indicator that would improve measurement of the food product itself, as opposed to the outward environment.

U.S. Pat. No. 4,057,029 to Seiter describes a time-temperature indicator having a time-temperature sensitive component that includes a layer of material wherein a temperature above a predetermined transition limit changes its composition from an impermeable, pseudo-crystalline state to one that is a permeable, liquid-crystalline state. The time component of the device is controlled by a predetermined rate of diffusion through the layer wherein a temperature sustained above a threshold initiates transition in composition of the device. Similar to the present invention, the Seiter device is adapted for attachment to a temperature sensitive object for measuring the product's exposed temperature environment over a period of time.

U.S. Pat. No. 5,085,802 to Jalinski describes an indicator system that monitors the temperature and time history of product using a dual system of specific reaction pairs to generate acid and alkali from two neutral substances. The preferred dynamic indicator system generators a constant pH buffer in the alkali range that is maintained until one of the substances is depleted, whereafter a pH change alters the visual appearance of a pH-sensitive dye. Other embodiments that describe temperature sensitive indicators are also provided, for which all are adapted for use with packaging foodstuffs that will be refrigerated or room temperature handled. This device is a pH based indicator system, describing its mode of operation. The present invention utilizes any color changing pigment or compound suited for a time-temperature environment threshold, including an assembly of conductor side and insulator side.

U.S. Pat. No. 5,053,339 to Patel describes another color change device for monitoring time-temperature storage history of perishable products. The device comprises an activator tape, and indicating tape and a barrier matrix therebetween. Diffusion through the barrier and matrix of the activating composition produces a visually observable color change at a temperature being monitored and preselected based on the design of the device. Similar to the aforementioned patents, no mention is made of directly measuring or facilitating the capture of a product temperature, as opposed to the environment temperature. The product temperature shows how the product is reacting to changes in the environment, and therefore its freshness. Drastic changes in the environment may not affect the product as quickly as an indicator may change.

U.S. Pat. No. 6,544,925 to Prusik describes a time-temperature indicator system for use in tracking the temperature exposure history of a perishable product. The device provides a visual signal once a predefined time-temperature threshold has been breached. The device comprises a first co-reactant of a color-forming reaction, along with a second, activator element. No mention of a device with insulative or conductive surfaces is described to ensure product temperature is being measured.

The present invention describes a safety seal for perishable food products. A label is affixed to the product, wherein the label comprises an inner, thermally conductive material and an outer, thermally insulative material. When the label crosses a predefined temperature threshold and remains above this temperature for a predefined period of time, the label changes its state to show the product has been improperly stored. The state of change may include a pigment change of the entire label, or in a defined pattern that forms a symbol or word. The layers allow the product to be measured, as opposed to the ambient air temperature thereabout. The prior art devices do not include such an assembly. Therefore, the present invention is substantially divergent in design elements from the prior art, and consequently it is clear that there is a need in the art for an improvement to existing food product safety label devices. In this regard the instant invention substantially fulfills these needs.

### SUMMARY OF THE INVENTION

In view of the foregoing disadvantages inherent in the known types of food product temperature and freshness monitoring device now present in the prior art, the present invention provides a new food product label wherein the same can be utilized for providing convenience for the user when monitoring the temperature of a perishable food product over a period of time, particularly during transport and storage prior to purchase.

It is therefore an object of the present invention to provide a new and improved food product temperature and freshness monitoring device that has all of the advantages of the prior art and none of the disadvantages.

Another object of the present invention is to provide a food product safety label for consumers to recognize whether a product has been stored and shipped in a proper environment to prevent spoilage prior to purchase.

Another object of the present invention is to provide a food product temperature and freshness monitoring device with an internal, color changing label that changes from a first state to a second state after crossing a predefined threshold temperature for a given period of time.

Another object of the present invention is to provide a food product temperature and freshness monitoring device with an internal, color changing label that is surrounded by a first, thermally-conducting layer and a second, thermally-insulating layer. The conductive layer faces the product side to facilitate measurement of the food product temperature, while the insulative layer faces outward, protecting the label from ambient temperature variations.

A final object of the present invention is to provide a food product temperature and freshness monitoring device that is of simple construction and is easily and inexpensively manufactured.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of a food product temperature and freshness monitoring device as described by the present invention in a working position, positioned in contact with a perishable food product.

FIG. 2 shows a cross section view of a food product temperature and freshness monitoring device as described by the present invention.

FIG. 3 shows an embodiment of a food product temperature and freshness monitoring device as described by the present invention.

FIG. 4 shows another embodiment of a food product temperature and freshness monitoring device as described by the present invention.

### DETAILED DESCRIPTION OF THE INVENTION

Reference is made herein to the attached drawings. Like reference numerals are used throughout the drawings to depict like or similar elements of the food product temperature and freshness monitoring device. For the purposes of presenting a brief and clear description of the present invention, the preferred embodiment will be discussed as used for monitoring the temperature of a perishable product over a given time period and reporting its condition to a consumer. The figures are intended for representative purposes only and should not be considered to be limiting in any respect.

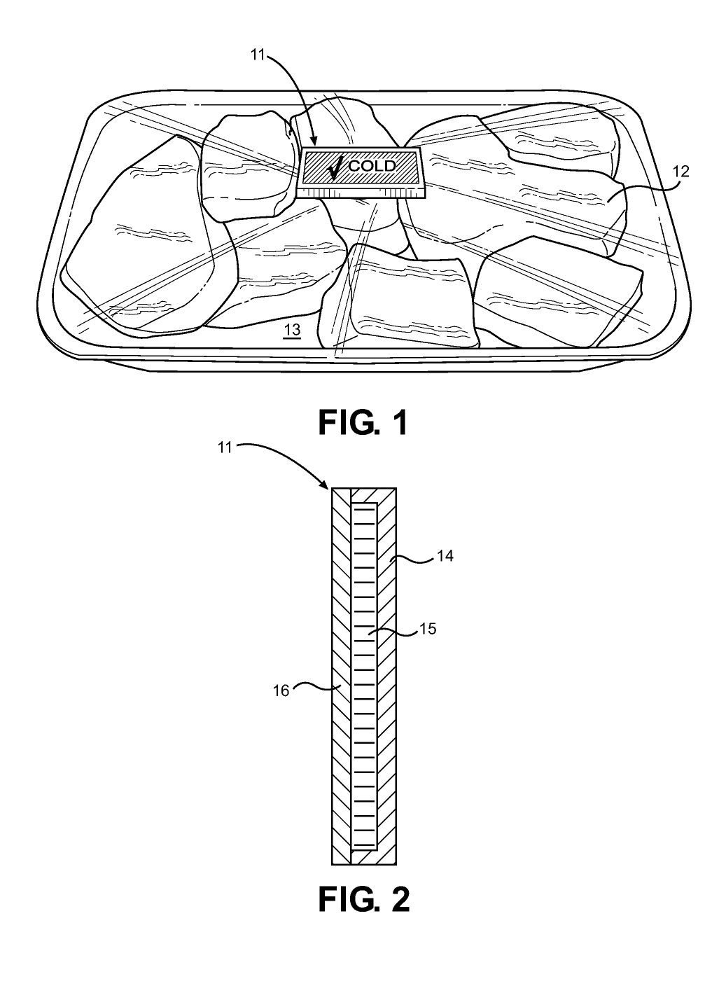

Referring now to FIG. 1, there is shown a perspective view of the present invention in a working position, wherein a food product temperature and freshness monitoring device 11 is placed in contact with a perishable food product 12 while in its packaging 13. The packaging 13 may encompass both the seal 11 and the food product 12, or alternatively the seal 11 may be placed on the outer surface of the packaging 13. The seal 11 provides a color changing device that monitors the temperature of the food product 12 and updates its color state depending on a predefined time-temperature curve. If the food product 12 crosses a predefined temperature threshold for a given time period, the pigment of the seal 11 will change to notify a consumer or seller that an unsatisfactory storage or transport environment was utilized prior to purchase. The seal 11 may provide a simple update in color, from a first state to a second state, or alternatively have a symbol or text that shows the product condition more readily apparent or obvious to an observer. As shown in FIG. 1, the first state of the product is illustrated as “COLD” with an associated check mark to indicate the food was stored and shipped in a satisfactory temperature environment. The seal 11 is preferably attached to the packaging using an adhesive along a corresponding interface.

Referring now to FIG. 2, there is shown a cross section side view of the food product temperature and freshness monitoring device as described by the present invention. The device comprises a multi-layered seal 11 that includes a backing layer 16, an outer layer 14 and an inner, temperature-sensitive layer 15 that updates its state based on a predefined time-temperature environment. The backing layer 16 is adapted to be in contact with the food product side, and comprises a thermally conductive layer that promotes heat flow from the food product into the inner layer 15. The outer layer 14 is conversely a thermally insulative material, which reduces heat flow through its cross section to prevent ambient outer temperatures from altering the behavior of the inner layer 15. This combination of layers allows the food product temperature to be monitored, as opposed to having temperature changes in the environment altering the pigment directly. The food product temperature is the key variable that will determine spoilage after a given period of time. The outside temperature can vary wildly, as the food product is transported and taken in and out of different temperature environments during the shipping and storing process.

The goal is to measure the product temperature throughout this cycle. The thermally insulative layer 14 may further wrap around and encase the edges of the inner layer 15 to provide complete insulation therearound. The inner layer 15 itself is a thermochromic material that alters its color based on passing a predefined temperature threshold for a given period of time. Once the color has changed, it cannot return to its original state, therefore providing a safety seal that cannot be altered by simply placing the perishable food product back into a cold environment. Once the threshold is passed, it will remain in its altered state. The means for accomplishing this task may comprise a label that undergoes a pH change, a diffusion process or any similar pigment or color changing means known to one skilled in the art. Similarly, the backing layer and outer layers may comprise any known conductor or insulator material that may provide their thermal benefits while providing so in a cost effective and appropriate manner, given the intent of the device. These include various sheet metallics for conduction and plastics or rubbers for insulation. It is not intended to limit the present invention to a set type of material, but to suggest a composition of such materials that will effectuate the given utility described herein.

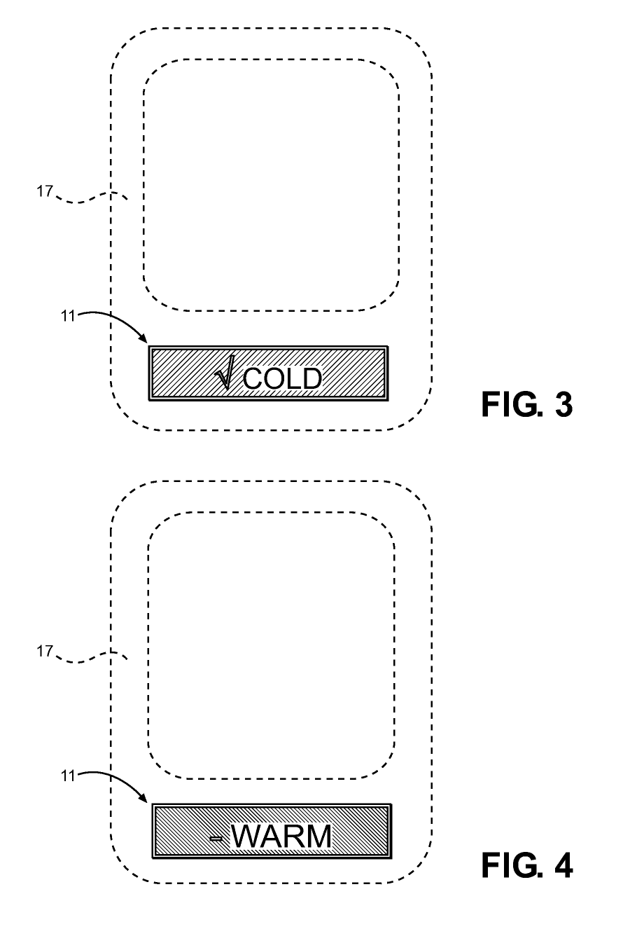

Referring now to FIGS. 3 and 4, there are shown two examples of the present invention being utilized with a packaging label 17, wherein the food product temperature and freshness monitoring device is incorporated onto the food packaging label 17 to provide a user with notice as to the condition of the product prior to purchase. Two embodiments of the indicator seal 11 are provided, wherein text and symbols are provided in a first and second state. The first, product safe state includes a check mark and a “COLD” indication, while the second, product unsafe or uncertain state includes a negative sign and a “WARM” indication. The seal is designed to warn consumers of possibly mishandled or improperly stored products that are perishable in nature and therefrom prone to spoilage if no properly handled.

Use of the present invention is intended to provide consumers with an easy and obvious way of determining how fresh a food product is, and how it was handled between preparation and delivery. The warning is intended to limit the instances of purchasing a spoiled or mishandled food product, which can lead to various illnesses. During the course of shipment from the manufacturer to the market, products are handed off between producer, shipper, seller and consumer. During each transaction, the products may be inspected, accepted or rejected by visualizing the seal. The seal itself is intended to be of simple construction, having a low production cost and being readily available for mass distribution. Its structure is suited for measuring the food product temperature profile as it is shipped and stored, and is less prone to give false positives with regard to the ambient environment and its associated swings in temperature.

To this point, the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A food product temperature and freshness monitoring device, comprising:
a seal with a backing layer, an inner layer and an outer layer;
said inner layer comprising a color changing material that alters its state from a first state to a second state after crossing a temperature threshold for a given period of time;
said backing layer comprising a thermally conductive material to promote heat flow into said inner layer;
said outer layer comprising a thermally insulative material to reduce heat flow into said inner layer.

2) A device as in claim 1, wherein said seal is placed in contact with a perishable food product and changes said state based on said food product temperature.

3) A device as in claim 2, wherein said seal further comprises adhesive along an interface with said perishable food product packaging.

4) A device as in claim 1, wherein said first and said second state may comprise both a color change and the formation of symbols or text.

5) A device as in claim 1, wherein said seal may be attached to a product label.
